(19) United States
(12) Patent Application Publication
(10) Pub. No.: US 2020/0064467 A1
(43) Pub. Date: Feb. 27, 2020

(54) MICROWAVE RADAR DISTANCE MEASURING METHOD, MICROWAVE RADAR, COMPUTER STORAGE MEDIUM, UNMANNED AERIAL VEHICLE AND CONTROL METHOD THEREOF

(71) Applicant: SZ DJI TECHNOLOGY CO., LTD., Shenzhen (CN)

(72) Inventors: Junxi WANG, Shenzhen (CN); Chunming WANG, Shenzhen (CN); Xumin WU, Shenzhen (CN)

(21) Appl. No.: 16/663,983

(22) Filed: Oct. 25, 2019

Related U.S. Application Data
(63) Continuation of application No. PCT/CN2017/082263, filed on Apr. 27, 2017.

(51) Int. Cl. G01S 13/94; G01S 13/93

(52) U.S. Cl. CPC G01S 13/94; G05D 1/101; G01S 13/9303

(57) ABSTRACT

The present disclosure provides an unmanned aerial vehicle (UAV) control method. The method includes controlling a microwave radar disposed on the UAV to transmit a microwave signal while rotating around a rotating shaft; acquiring a frequency of an intermediate frequency signal based on a frequency of the transmitted signal and a frequency of an echo signal; determining a distance between the UAV and a surrounding obstacle based on the frequency of the intermediate frequency signal; and adjusting a flight path of the UAV based on the distance between the UAV and the surrounding obstacle.

### CROSS-REFERENCE TO RELATED APPLICATION

This application is a continuation application of International Application No. PCT/CN2017/082263, filed on Apr. 27, 2017, the entire content of which is incorporated herein by reference.

### TECHNICAL FIELD

The present disclosure relates to the field of agricultural unmanned aerial vehicle (UAV) technology, and more specifically, to a microwave radar distance measuring method, a microwave radar, a computer storage medium, an unmanned aerial vehicle and control method thereof.

### BACKGROUND

With the rapid advancement in science and technology, the technology related to UAVs has become more mature, and the applications of the UAVs have increased as well. For example, UAVs can be used in various fields such as agriculture, forestry, transportation, water conservancy, and military. In particular, UAVs have played an important role in the field of agricultural aviation technology.

When an agricultural UAV is in operation, the agricultural UAV will need to acquire its flight height. In conventional technology, the agricultural UAVs generally use a barometer or a global positioning system (GPS) to acquire the flight height of the agricultural UAV. Alternatively, the agricultural UAV may use a distance sensor disposed directly under the agricultural UAV to measure the distance immediately below the UAV at the moment of measurement.

However, in conventional technology, the barometer or the GPS may only acquire the absolute height of the UAV relative to the sea level, and the height of the UAV relative to the ground may not be measured. As such, the height of the terrain in front of the agricultural UAV may not be measured while the agricultural UAV is in operation, thereby reducing the efficiency of the agricultural spraying operation of the agricultural UAV. Further, if the flight height is measured by using the distance sensor disposed directly under the agricultural UAV, the agricultural UAV may not be able to acquire the relative front and rear carrier height information, thereby affecting the safety and reliability of the operation of the agricultural UAV.

### SUMMARY

One aspect of the present disclosure provides an unmanned aerial vehicle (UAV) control method. The method includes controlling a microwave radar disposed on the UAV to transmit a microwave signal while rotating around a rotating shaft; acquiring a frequency of an intermediate frequency signal based on a frequency of the transmitted signal and a frequency of an echo signal; determining a distance between the UAV and a surrounding obstacle based on the frequency of the intermediate frequency signal; and adjusting a flight path of the UAV based on the distance between the UAV and the surrounding obstacle.

Another aspect of the present disclosure provides A UAV. The UAV includes a frame; a microwave radar mounted on the frame, and the microwave is rotatable around a rotation shaft; and a flight controller communicatively connected to the microwave radar. The microwave radar is configured to transmit a microwave signal while rotating around the rotating shaft, acquire a frequency of an intermediate frequency signal according to a frequency of the transmitted signal and a frequency of an echo signal, and determine a distance between the UAV and a surrounding obstacle based on the frequency of the intermediate frequency signal; and the flight controller is configured to adjust a flight path of the UAV based on the distance between the UAV and the surrounding obstacle.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart illustrating a microwave radar distance measuring method according to an embodiment of the present disclosure.

FIG. 2 is a flowchart of determining a distance between the microwave radar and a reflecting target based on a frequency of an intermediate frequency signal according to an embodiment of the present disclosure.

FIG. 3 is a flowchart illustrating the microwave radar distance measuring method according to another embodiment of the present disclosure.

FIG. 4 is a flowchart of acquiring a Doppler frequency generated by a vertical velocity of the microwave radar relative to the reflecting target according to an embodiment of the present disclosure.

FIG. 5 is a flowchart of acquiring a frequency of the intermediate frequency signal after a frequency mixing of a frequency of a transmitted signal and a frequency of an echo signal according to an embodiment of the present disclosure.

FIG. 6 a diagram illustrating a triangular wave after performing a triangular wave modulation processing on the transmitted signal according to an embodiment of the present disclosure.

FIG. 7 is a structural diagram illustrating the microwave radar according to an embodiment of the present disclosure.

FIG. 8 is a flowchart illustrating a UAV control method according to an embodiment of the present disclosure.

FIG. 9 is a flowchart illustrating the UAV control method according to another embodiment of the present disclosure.

FIG. 10 is a structural diagram illustrating a UAV according to an embodiment of the present disclosure.

### DETAILED DESCRIPTION OF THE EMBODIMENTS

The technical solutions provided in the embodiments of the present disclosure will be described below with reference to the drawings. However, it should be understood that the following embodiments do not limit the disclosure. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Unless otherwise defined, all technical and scientific terms used herein have the same meaning as those commonly understood by the skilled in the art. The terminology used in the specification of the present disclosure is for the purpose of describing particular embodiments only and is not intended to limit the disclosure. The term “and/or” as used herein includes any and all combinations of one or more of the associated listed items.

Hereinafter, the embodiments of the present disclosure will be described in detail with reference to the accompanying drawings. In the case of no conflict, the embodiments and the features thereof can be combined with each other.

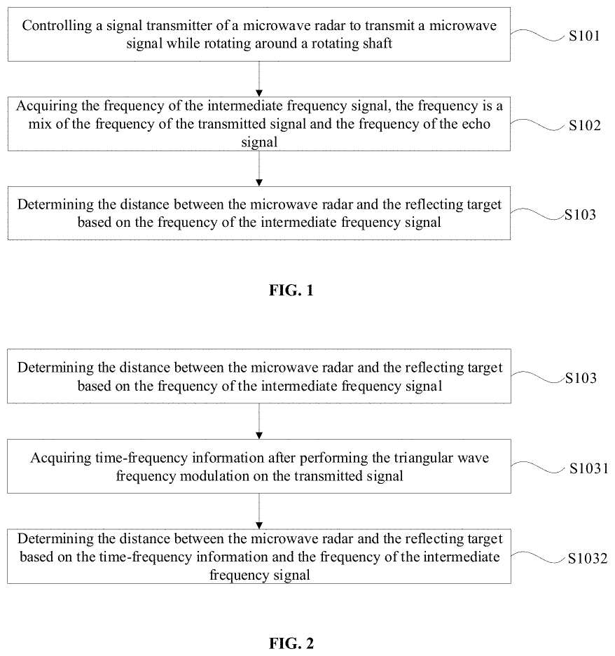

FIG. 1 is a flowchart illustrating a microwave radar distance measuring method according to an embodiment of the present disclosure, and FIG. 5 is a flowchart of acquiring a frequency of an intermediate frequency signal after a frequency mixing of a frequency of a transmitted signal and a frequency of an echo signal according to an embodiment of the present disclosure. As can be seen from FIG. 1 and FIG. 5, the present disclosure provides a microwave radar distance measuring method. The distance measuring method may be used to accurately measure the distance between a microwave radar and a reflecting object. The reflecting object may be a ground, an obstacle on the ground, an obstacle in the air, or the like. The microwave radar distance measuring method is described in detail below.

S101, controlling a signal transmitter of a microwave radar to transmit a microwave signal while rotating around a rotating shaft.

In one embodiment, the microwave radar may be installed on the UAV to determine the distance between the UAV and the reflecting object by using the distance between the received microwave radar and the reflecting object. During installation, the microwave radar may be mounted on the UAV through a rotating shaft and the microwave radar may rotate around the rotating shaft. It should be noted that the microwave radar may rotate horizontally around the rotating shaft (e.g., the rotating shaft may be considered as being perpendicular to the ground at this point); or, the microwave radar may perform a vertical rotation movement (e.g., the rotating shaft may be consider as being parallel to the ground at this point). In order to accurately acquire the distance between the microwave radar and the reflecting object, the signal transmitter of the microwave radar may be controlled to emit a microwave signal when the microwave radar is performing the rotation movement around the rotating shaft. As such, the microwave signal generated by the rotational movement may include a plurality of beams of microwave signals that may be uniformly distributed at different positions, thereby effectively detecting the distance information between the microwave radar and the reflecting object at each position.

S102, acquiring the frequency of the intermediate frequency signal that is a mix of the frequency of the transmitted signal and the frequency of the echo signal.

For a transmitted signal at a position, in order to determine the distance between the microwave radar and the reflecting target at the position, the frequency of the intermediate frequency signal corresponding to the position may be acquired, and the frequency of the intermediate frequency signal may be directly received and acquired. It should be noted that the frequency of the intermediate frequency signal may be acquired by mixing the frequency of the transmitted signal and the frequency of the echo signal. In some embodiments, the echo signal may be a feedback signal after the reflecting target receives the transmitted signal. As can be seen from the above described, the frequency of the intermediate frequency signal may be acquired by acquiring the frequency of the transmitted signal and the frequency of the echo signal, and performing a mix frequency calculation on these two signals. Alternatively, another method may be used to acquire the frequency of the intermediate frequency signal after the mix of the frequency of the transmitted signal and the frequency of the echo signal, which is described in detail below.

S1021, acquiring the frequency of a rising period of a triangular wave modulation period and the frequency of a falling period of the triangular wave modulation period after performing a triangular wave frequency modulation on the transmitted signal.

After acquiring the transmitted signal, a triangular wave frequency modulation process may be performed on the transmitted signal to acquire modulated triangular wave signal data. The triangular wave image data may be obtained from the modulated triangular wave signal data. By analyzing the trend of the image data, the frequency of the rising period of the triangular wave modulation period and the frequency of the falling period of the triangular wave modulation period may be obtained. It should be noted that the frequency of the rising period of the triangular wave modulation period may be the frequency information corresponding to the rising trend of the triangular wave modulation period, and the frequency of the falling period of the triangular wave modulation period may be the frequency information corresponding to the falling trend of the triangular wave modulation period.

S1022, determining the frequency of the intermediate frequency signal based on the frequency of the rising period of the triangular wave modulation period and the frequency of the falling period of the triangular wave modulation period.

After acquiring the frequency of the rising period of the triangular wave modulation period and the frequency of the falling period of the triangular wave modulation period, the frequency of the intermediate frequency signal may be determined based on the frequency of the rising period of the triangular wave modulation period and the frequency of the falling period of the triangular wave modulation period. In particular, the frequency of the intermediate frequency signal may have a linearly relationship with sum of the frequency of the rising period of the triangular wave modulation period and the frequency of the falling period of the triangular wave modulation period.

In one embodiment, the following formula may be used to determine the frequency of the intermediate frequency signal.

$${f}_{b} = \frac{{f}_{bup} + {f}_{bdown}}{2} ,$$

where f_{b} may be the frequency of the intermediate frequency signal, f_{bdown} may be the frequency of the falling period of the triangular wave modulation period, and f_{bup} may be the frequency of the rising period of the triangular wave modulation period. It should be noted that those skilled in the art may modify the coefficient of ½ mentioned above based on other design requirements or specifications, and the coefficient is not limited in the present disclosure. By determining the frequency of the intermediate frequency signal based on the frequency of the rising period of the triangular wave modulation period and the frequency of the falling period of the triangular wave modulation period, the accurately and reliability of the acquisition of the frequency of the intermediate frequency signal may be effectively improved, thereby further ensuring the accuracy of the distance measuring method.

S103, determining the distance between the microwave radar and the reflecting target based on the frequency of the intermediate frequency signal.

After acquiring the frequency of the intermediate frequency signal, the frequency of the intermediate frequency signal may be analyzed, and the distance between the microwave radar and the reflecting target may be determined based on a predetermined analytical processing rule. It should be noted that the distance between the microwave radar and the reflecting target may be the distance of a straight line. Further, after perform the analytical processing on each of the microwave signals transmitted by the signal transmitter of the microwave radar while rotating around the rotating shaft, the distance between each position of the reflecting target at which the microwave radar may reach may be acquired. As such, the height information of the microwave radar and the landscape information formed by a plurality of reflecting targets may be determined. Therefore, when the microwave radar is mounted on the UAV, the safety and reliability of the flight of the UAV may be effectively ensured.

By using the microwave radar distance measuring method provided in the present disclosure, the height information of the microwave radar and the landscape information formed by a plurality of reflecting targets may be determined by controlling the signal transmitter of the microwave radar to transmit a microwave signal while rotating around a rotating shaft, acquiring the frequency of the intermediate frequency signal, and determining the distance between the microwave radar and the reflecting targets based on the frequency of the intermediate frequency signal. Further, when the microwave radar is mounted on the UAV, the safety and reliability of the flight of the UAV may be effectively ensured and the practicality of the distance measuring method may be improved, which is beneficially to the market promotion and application.

FIG. 2 is a flowchart of determining the distance between the microwave radar and the reflecting target based on the frequency of the intermediate frequency signal according to an embodiment of the present disclosure. On the basis of the previous embodiment and FIGS. 1-2, it can be seen that the present disclosure does not limit the specific implementation method of the determination of the distance between the microwave radar and the reflecting target based on the frequency of the intermediate frequency signal, and those skilled in the art may modify the method based on the specific design requirements. In one embodiment, determining the distance between the microwave radar and the reflecting target based on the frequency of the intermediate frequency signal may be as follow.

S1031, acquiring time-frequency information after performing the triangular wave frequency modulation on the transmitted signal.

The time-frequency information may include 0.5 times of a modulation bandwidth, a triangular wave modulation period, and an electromagnetic wave propagation speed. More specifically, after acquiring the transmitted signal, a triangular wave frequency modulation processing may be performed on the transmitted signal to acquire the triangular wave signal data corresponding to the transmitted signal, and the time-frequency information mentioned above may be acquired from the triangular wave signal data.

S1032, determining the distance between the microwave radar and the reflecting target based on the time-frequency information and the frequency of the intermediate frequency signal.

After acquiring the time-frequency information, the distance between the microwave radar and the reflecting target may be determined based on the time-frequency information and the frequency of the intermediate frequency signal. More specifically, the distance between the microwave radar and the reflecting target may have a linear relationship with the product of the frequency of the intermediate frequency signal, the triangular wave modulation period, and the electromagnetic wave propagation speed. Further, the distance between the microwave radar and the reflecting target may be inversely proportional to the 0.5 times of the modulation bandwidth.

In one embodiment, the following formula may be used to acquire the distance between the microwave radar and the reflecting target.

$$R = \frac{{T}_{m} c}{8 Δ f} {f}_{b} ,$$

where R may be the distance between the microwave radar and the reflecting target; Tₘ may be the triangular wave modulation period, c may be the electromagnetic wave propagation speed, f_{b} may be the frequency of the intermediate frequency signal, and Δf may be the 0.5 times of the modulation bandwidth. It should be noted that those skilled in the art may modify the coefficient of ⅛ mentioned above based on other design requirements or specifications, and the coefficient is not limited in the present disclosure.

By acquiring the time-frequency information after performing the triangular wave frequency modulation on the transmitted signal, the distance between the microwave radar and the reflecting target may be acquired based on the time-frequency information and the frequency of the intermediate frequency signal, thereby effectively improving the accuracy and reliability of the distance acquisition between the microwave radar and the reflecting target.

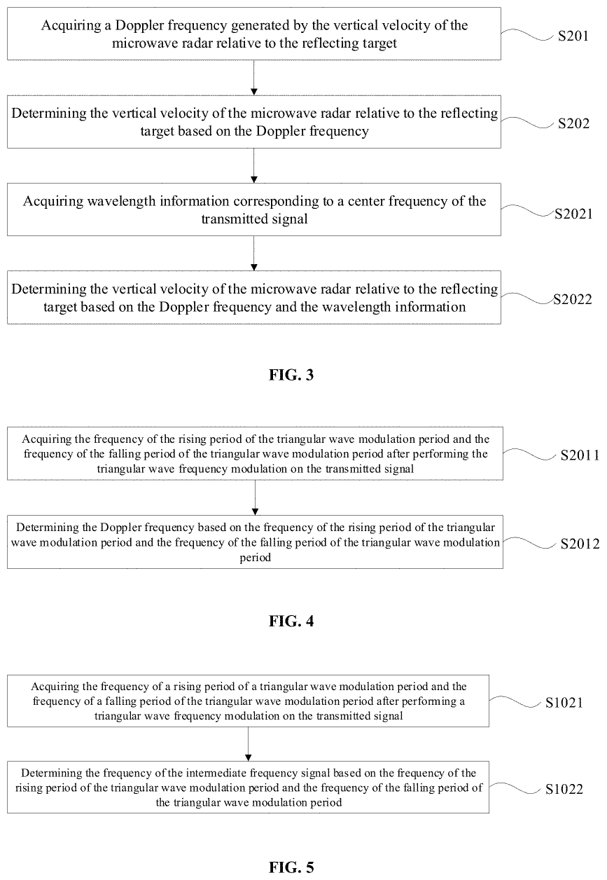

FIG. 3 is a flowchart illustrating the microwave radar distance measuring method according to another embodiment of the present disclosure, and FIG. 4 is a flowchart of acquiring a Doppler frequency generated by a vertical velocity of the microwave radar relative to the reflecting target according to an embodiment of the present disclosure. On the basis of the previous embodiment and FIGS. 3-4, it can be seen that in order to improve the practicality of the distance measuring method, in one embodiment, the distance measuring method may be set as follow.

S201, acquiring a Doppler frequency generated by the vertical velocity of the microwave radar relative to the reflecting target.

In one embodiment, the Doppler frequency may be directly acquired. In some embodiments. Alternatively, the acquisition of the Doppler frequency generated by the vertical velocity of the microwave radar relative to the reflecting target may be set as follow.

S2011, acquiring the frequency of the rising period of the triangular wave modulation period and the frequency of the falling period of the triangular wave modulation period after performing the triangular wave frequency modulation on the transmitted signal.

S2012, determining the Doppler frequency based on the frequency of the rising period of the triangular wave modulation period and the frequency of the falling period of the triangular wave modulation period.

In particular, the Doppler frequency may have a linear relationship with the difference between the frequency of the falling period of the triangular wave modulation period and the frequency of the rising period of the triangular wave modulation period.

In one embodiment, the Doppler frequency may be determined based on the following formula.

$${f}_{d} = \frac{{f}_{bdown} - {f}_{bup}}{2} ,$$

where f_{d} may be the Doppler frequency, f_{bdown} may be the frequency of the falling period of the triangular wave modulation period, and f_{bup} may be the frequency of the rising period of the triangular wave modulation period. It should be noted that those skilled in the art may modify the coefficient of ½ mentioned above based on other design requirements or specifications, and the coefficient is not limited in the present disclosure. By determining the Doppler frequency based on the frequency of the rising period of the triangular wave modulation period and the frequency of the falling period of the triangular wave modulation period, the accurately and reliability of the acquisition of the Doppler frequency may be effectively improved, thereby further ensuring the accuracy of the distance measuring method.

S202, determining the vertical velocity of the microwave radar relative to the reflecting target based on the Doppler frequency.

After acquiring the Doppler frequency, the Doppler frequency may be analyzed to acquire the vertical velocity of the microwave radar relative to the reflecting target. More specifically, the determination of the vertical velocity of the microwave radar relative to the reflecting target based on the Doppler frequency may be set as follow.

S2021, acquiring wavelength information corresponding to a center frequency of the transmitted signal.

In one embodiment, the wavelength information may be acquired by first acquiring the center frequency of the transmitted signal and the propagation speed of the electromagnetic wave, then the wavelength information may be determined based on the propagation speed of the electromagnetic wave and the center frequency of the transmitted signal. More specifically, the wavelength information may be determined by using the formula of λ=C/f, where λ may be the wavelength information corresponding to the center frequency of the transmitted signal, C may be the propagation speed of the electromagnetic wave, and f may be the center frequency of the transmitted signal. As such, the accuracy and reliability of the acquisition of the wavelength information may be effectively ensured.

S2022, determining the vertical velocity of the microwave radar relative to the reflecting target based on the Doppler frequency and the wavelength information.

After acquiring the wavelength information, the vertical velocity of the microwave radar relative to the reflecting target may be determined based on the Doppler frequency and the wavelength information. In particular, the vertical velocity of the microwave radar relative to the reflecting target may have a linear relationship with the product of the Doppler frequency and the wavelength information.

In one embodiment, the vertical velocity of the microwave radar relative to the reflecting target may be determined by using the formula of

$$v = \frac{λ}{2} {f}_{d} ,$$

where v may be the vertical velocity of the microwave radar relative to the reflecting target, λ may be the wavelength information corresponding to the center frequency of the transmitted signal, and f_{d} may be the Doppler frequency. It should be noted that when the microwave radar is mounted on the UVA and the UAV is in a hovering state, the vertical velocity of the UAV at this time may be 0, that is, the vertical velocity of the microwave radar relative to the reflecting target may also be 0.

By acquiring the vertical velocity of the microwave radar relative to the reflecting target on the basis of acquiring the distance information between the microwave radar and the reflecting target, it may be beneficial to control the state of the microwave radar, thereby ensuring the safety and reliability of the flight of the UAV and further improving the stability and reliability of the distance measuring method.

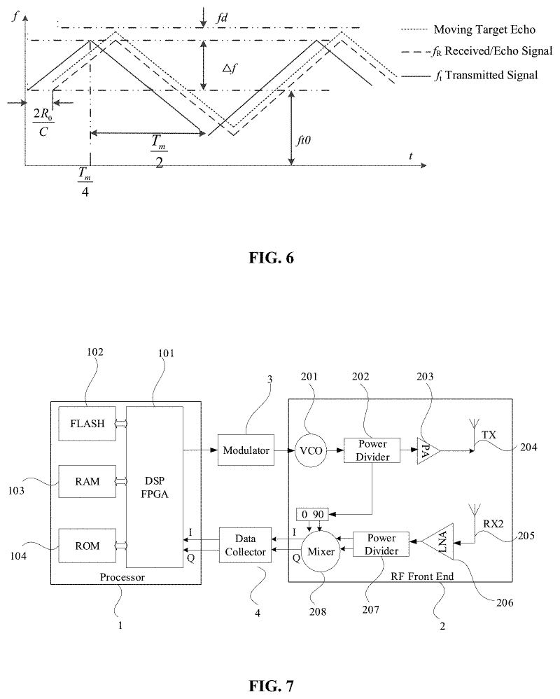

FIG. 6 a diagram illustrating a triangular wave after performing the triangular wave modulation processing on the transmitted signal according to an embodiment of the present disclosure. Referring to FIG. 6, it can be seen that after performing the triangular wave modulation on the transmitted signal, image data as shown in FIG. 6 may be obtained. In particular, the frequency of the transmitted signal fₜ may change periodically based on the amplitude and frequency of the triangular wave. f_{R} may be the frequency of the received signal (i.e., the echo signal) fr returned from the reflecting target, and its change in frequency may be the same as the transmitted signal with a time delay t=2R₀/c (e.g. a stationary target). More specifically, the frequency of the transmitted signal and the frequency of the received signal may be written as the following expression.

$${f}_{i} = {f}_{0} + \frac{df}{dt} t = {f}_{0} + \frac{Δ f}{{T}_{m} / 4} t \\ {f}_{R} = {f}_{0} + \frac{df}{dt} ( t - Δ t ) = {f}_{0} + \frac{4 Δ f}{{T}_{m}} ( t - \frac{2 {R}_{0}}{c} ) \qquad ( 1 \text{-} 1 )$$

In the above expression, f₀ may be the center frequency of the transmitted signal in hertz (Hz), Δf may be the 0.5 times of the modulation bandwidth in hertz (Hz), Tₘ may be the triangular wave modulation period in seconds (s), R₀ may be the distance between the microwave radar and the reflecting target in meters (m), and c may be the electromagnetic wave propagation speed in meters/second (m/s).

By mixing the frequency of the transmitted signal with the frequency of the received echo signal, the frequency of the intermediate frequency signal f_{b} may be obtained. The frequency of the intermediate frequency signal f_{b} may be written as the following expression.

$${f}_{b} = {f}_{t} - {f}_{r} = \frac{8 Δ {fR}_{0}}{{cT}_{m}} \qquad ( 1 \text{-} 2 )$$

In the above expression, fₜ may be the frequency of the transmitted signal in hertz (Hz), fᵣ may be the frequency of the echo signal in hertz (Hz), Δf may be the 0.5 times of the modulation bandwidth in hertz (Hz), Tₘ may be the triangular wave modulation period in seconds (s), R₀ may be the distance between the microwave radar and the reflecting target in meters (m), and c may be the electromagnetic wave propagation speed in meters/second (m/s).

For the echo of the distance of a stationary target, an average beat frequency f_{bav} may be obtained by performing a frequency estimation on one cycle of the intermediate frequency signal. The average beat frequency f_{bav} may be written as the following expression.

$${f}_{bav} = \frac{8 Δ fR}{{T}_{m} c} \{ \frac{{T}_{m} - \frac{2 {R}_{0}}{c}}{{T}_{m}} \} \qquad ( 1 \text{-} 3 )$$

In practice, a signal value distance measurement generally satisfies the following condition:

$${T}_{m} ≫ \frac{2 {R}_{0}}{c} \qquad ( 1 \text{-} 4 )$$

For example, when the modulation period Tₘ is 10 ms and the distance R₀ is 150 m, the corresponding time delay may be 0.001 ms, which is much smaller than Tₘ. As such, the following expression may be obtained.

$${f}_{bav} \approx \frac{8 Δ fR}{{T}_{m} c} = {f}_{b} \qquad ( 1 \text{-} 5 )$$

Therefore, the distance between the microwave radar and the reflecting target may be estimated by using the following expression.

$$R = \frac{{T}_{m} c}{8 Δ f} {f}_{b} \qquad ( 1 \text{-} 6 )$$

When the UAV is in motion, the echo signal received by the microwave radar may no longer be stationary. Assuming the distance between the microwave radar and the reflecting target is R and the vertical velocity is v, the beat frequency signal at the rising period and falling period of the triangular wave modulation period may be expressed as (f_{d}<f_{b}), where f_{bup} may be the beat frequency at the rising period of the triangular wave modulation period and f_{bdown} may be the beat frequency at the falling period of the triangular wave modulation period.

$$\begin{matrix} & ( 1 \text{-} 7 ) \\ {f}_{bdown} = {f}_{b} + {f}_{d} = \frac{8 Δ f}{{T}_{m} c} R + {f}_{d} & ( 1 \text{-} 8 ) \\ {f}_{d} = \frac{2 v}{λ} & ( 1 \text{-} 9 )\end{matrix}$$

In particular, f_{d} may be the Doppler frequency, which may be generated by the vertical velocity of a moving target. By combining expressions (1-7) and (1-8), f_{b} and f_{d} may be respectively obtained by using the following expression.

$${f}_{b} = \frac{{f}_{bup} + {f}_{bdown}}{2} \\ {f}_{d} = \frac{{f}_{bdown} - {f}_{bup}}{2} \qquad ( 1 \text{-} 10 )$$

Further, by combining expressions (1-6) and (1-9), the distance between the microwave radar and the reflecting target, and the vertical velocity may be obtained by using the following expression.

$$R = \frac{{cT}_{m}}{8 Δ f} {f}_{b} = \frac{{cT}_{m}}{8 Δ f} ( \frac{{f}_{bup} + {f}_{bdown}}{2} ) \\ v = \frac{λ}{2} {f}_{d} = \frac{λ}{2} ( \frac{{f}_{bdown} - {f}_{bup}}{2} ) \qquad ( 1 \text{-} 11 )$$

In summary, the distance between the microwave radar and the reflecting target, and the vertical velocity of the microwave radar relative to the reflecting target may be accurately obtained, which may ensure the accuracy and reliability of the distance measuring method. When the microwave radar is mounted on the UAV, the safety and reliability of the operation of the UAV may be ensured, and the practicality of the distance measuring method may be further improved.

FIG. 7 is a structural diagram illustrating a microwave radar according to an embodiment of the present disclosure. Referring to FIG. 7, an embodiment of the present disclosure provides a microwave radar, which may be mounted on a UAV. More specifically, the microwave radar may include one or more processors 1 that may work separately or cooperatively.

The processor 1 may be configured to control a signal transmitter of the microwave radar to transmit a microwave signal while rotating around a rotating shaft; acquire the frequency of the intermediate frequency signal that is a mix of the frequency of the transmitted signal and the frequency of the echo signal; and determine the distance between the microwave radar and the reflecting target based on the frequency of the intermediate frequency signal.

In one embodiment, the processor 1 may be configured to determine the distance between the microwave radar and the reflecting target based on the frequency of the intermediate frequency signal, which may include acquiring time-frequency information after performing the triangular wave frequency modulation on the transmitted signal; and determining the distance between the microwave radar and the reflecting target based on the time-frequency information and the frequency of the intermediate frequency signal.

The time-frequency information may include 0.5 times of a modulation bandwidth, a triangular wave modulation period, and an electromagnetic wave propagation speed. Further, the determined distance between the microwave radar and the reflecting target may have a linear relationship with the product of the frequency of the intermediate frequency signal, the triangular wave modulation period, and the electromagnetic wave propagation speed. Further, the distance between the microwave radar and the reflecting target may be inversely proportional to the 0.5 times of the modulation bandwidth.

In order to improve the practicality of the microwave radar, the processor 1 may be further configured to acquire a Doppler frequency generated by the vertical velocity of the microwave radar relative to the reflecting target, and determine the vertical velocity of the microwave radar relative to the reflecting target based on the Doppler frequency.

More specifically, the processor 1 may be configured to determine the vertical velocity of the microwave radar relative to the reflecting target based on the Doppler frequency, which may include acquiring wavelength information corresponding to a center frequency of the transmitted signal, and determining the vertical velocity of the microwave radar relative to the reflecting target based on the Doppler frequency and the wavelength information.

In particular, the vertical velocity of the microwave radar relative to the reflecting target may have a linear relationship with the product of the Doppler frequency and the wavelength information.

Further, the processor 1 may be configured to acquire the Doppler frequency generated by the vertical velocity of the microwave radar relative to the reflecting target by acquiring the frequency of the rising period of the triangular wave modulation period and the frequency of the falling period of the triangular wave modulation period after performing the triangular wave frequency modulation on the transmitted signal; and determining the Doppler frequency based on the frequency of the rising period of the triangular wave modulation period and the frequency of the falling period of the triangular wave modulation period.

In particular, the Doppler frequency may have a linear relationship with the difference between the frequency of the falling period of the triangular wave modulation period and the frequency of the rising period of the triangular wave modulation period.

In addition, in one embodiment, the processor 1 may be further configured to acquire the frequency of the intermediate frequency signal after the mix of the frequency of the transmitted signal and the frequency of the echo signal. More specifically, the processor 1 may be configured to acquire the frequency of a rising period of a triangular wave modulation period and the frequency of a falling period of the triangular wave modulation period after performing a triangular wave frequency modulation on the transmitted signal; and determine the frequency of the intermediate frequency signal based on the frequency of the rising period of the triangular wave modulation period and the frequency of the falling period of the triangular wave modulation period.

In particular, the frequency of the intermediate frequency signal may have a linearly relationship with sum of the frequency of the rising period of the triangular wave modulation period and the frequency of the falling period of the triangular wave modulation period.

The specific principles and implementation manners of the microwave radar provided in the present embodiment are similar to the embodiments shown in FIGS. 1-6, and detailed are not described herein again.

By using the microwave radar provided in the present disclosure, the height information of the microwave radar and the landscape information formed by a plurality of reflecting targets may be determined by controlling the signal transmitter of the microwave radar to transmit a microwave signal while rotating around a rotating shaft, acquiring the frequency of the intermediate frequency signal, and determining the distance between the microwave radar and the reflecting targets based on the frequency of the intermediate frequency signal. Further, when the microwave radar is mounted on the UAV, the safety and reliability of the flight of the UAV may be effectively ensured and the practicality of the microwave radar may be improved, which is beneficially to the market promotion and application.

Referring to FIG. 7, in one embodiment, other than the processor 1, the microwave radar may further include a RF front end 2 in communication with the processor 1. The RF front end 2 may include a signal transmitter 204 for transmitting signals, and a power amplifier (PA) 203, a power divider 202, and a voltage controlled oscillator (VCO) 201 that may be sequentially connected to the signal transmitter 204. Further, the RF front end 2 may further include a signal receiver 205 for receiving the echo signals, a low noise amplifier (LNA) 206 connected to the signal receiver 205, a power divider 207, a mixer 208, and the like. The signal transmitter 204 and the signal receiver 205 may include a microstrip antenna. In addition, the power divider 202 for the connection to the signal transmitter 204 may be connected to the mixer 208, the voltage controlled oscillator 201 may be connected to the processor 1 through a modulator 3 for adjusting a waveform and the mixer 208 may be connected to the processor 1 via an analog-to-digital converter (ADC) and a data collector 4.

In addition, in some embodiments, the one processor 1 may be configured to include a digital signal processing (DSP) unit and a field programmable gate array (FPGA) 101, and a memory unit connected to a digital signal processor 101. The memory unit may include a flash memory (FLASH) 102, a random access memory (RAM) 103, a read-only memory (ROM) 104, and the like.

The operating principle of the microwave radar may be that the processor 1 may control the signal transmitter 204 to transmit a microwave signal through the modulator 3. More specifically, the processor 1 may generate a modulated signal which may be sent through the modulator 3 to the VOC 201. Under the modulation voltage of the VOC 201, the modulated signal may generate a chirp signal, and two signals may be generated when the chirp signal passes through the power divider 202. In particular, one signals may be transmitted to the signal transmitter 204 by the power amplifier 203, such that the signal transmitter 204 may radiate the microwave signal outward, and the other signal may be transmitted to the mixer 208 for the frequency mix processing with the received echo signal to acquire the frequency of the intermediate frequency signal.

When the emitted microwave signal hits the reflecting target, the reflecting target may return an echo signal, which may be received by the signal receiver 205. The received echo signal may be processed by the LNA 206 and the power divider 207, and then transmitted to the mixer 208. The mixer 208 may mix the previously received transmitted signal with the echo signal, such that the frequency of the intermediate frequency signal may be acquired. Further, the intermediate frequency signal may be transmitted to the processor 1 through the ADC and the data collector 4, such that the processor 1 may acquire the intermediate frequency signal, and further determine the distance between the microwave radar and the reflecting target based on the frequency of the intermediate frequency signal, and the vertical velocity of the microwave radar relative to the reflecting target.

More specifically, after the processor 1 acquires the frequency of the intermediate frequency signal, in addition to the processing manner implemented in the above embodiments, the frequency of the intermediate frequency signal may be sequentially processed by using a time domain frequency echo signal processing, an ADC T_{cm} acquisition processing, a time domain windowing processing, a fast Fourier transform (FFT) processing, a constant false alarm rate (CFAR) peak detection processing, a signal processing analysis, and the like. As such, the distance between the microwave radar and the reflecting target and the vertical velocity of the microwave radar relative to the reflecting target may be acquired.

It should be noted that the microwave radar mentioned above may be a frequency modulated continuous wave (FMCW) radar, and the frequency of the transmitted signal may operation around 24 GHz. More specifically, the center frequency of the transmitted signal may be 25.15 GHz, the bandwidth may be 200 MHz, and a variation of plus and minus 0.1 GHz. As such, it may be determined that the operating frequency interval of the transmitted signal may be between 24.25 GHz and 24.05 GHz.

Another aspect of the present disclosure provides a computer storage medium. The computer storage medium may store program instructions, and the program instructions may be used to implement the control a signal transmitter of the microwave radar to transmit a microwave signal while rotating around a rotating shaft; the acquisition of the frequency of the intermediate frequency signal that is a mix of the frequency of the transmitted signal and the frequency of the echo signal, and the determination of the distance between the microwave radar and the reflecting target based on the frequency of the intermediate frequency signal.

In one embodiment, the acquisition of the frequency of the intermediate frequency signal after the mix of the frequency of the transmitted signal and the frequency of the echo signal may include: acquiring the frequency of a rising period of a triangular wave modulation period and the frequency of a falling period of the triangular wave modulation period after performing a triangular wave frequency modulation on the transmitted signal; and determining the frequency of the intermediate frequency signal based on the frequency of the rising period of the triangular wave modulation period and the frequency of the falling period of the triangular wave modulation period.

In particular, the frequency of the intermediate frequency signal may have a linearly relationship with sum of the frequency of the rising period of the triangular wave modulation period and the frequency of the falling period of the triangular wave modulation period.

In one embodiment, the determination of the distance between the microwave radar and the reflecting target based on the frequency of the intermediate frequency signal may include: acquiring time-frequency information after performing the triangular wave frequency modulation on the transmitted signal; and determining the distance between the microwave radar and the reflecting target based on the time-frequency information and the frequency of the intermediate frequency signal.

The time-frequency information may include 0.5 times of a modulation bandwidth, a triangular wave modulation period, and an electromagnetic wave propagation speed. Further, the determined distance between the microwave radar and the reflecting target may have a linear relationship with the product of the frequency of the intermediate frequency signal, the triangular wave modulation period, and the electromagnetic wave propagation speed. Further, the distance between the microwave radar and the reflecting target may be inversely proportional to the 0.5 times of the modulation bandwidth.

In order to improve the practicality of the microwave radar, the program instructions may be further configured to implement the acquisition of a Doppler frequency generated by the vertical velocity of the microwave radar relative to the reflecting target, and the determination of the vertical velocity of the microwave radar relative to the reflecting target based on the Doppler frequency.

In one embodiment, the acquisition of the Doppler frequency generated by the vertical velocity of the microwave radar relative to the reflecting target may include: acquiring the frequency of the rising period of the triangular wave modulation period and the frequency of the falling period of the triangular wave modulation period after performing the triangular wave frequency modulation on the transmitted signal; and determining the Doppler frequency based on the frequency of the rising period of the triangular wave modulation period and the frequency of the falling period of the triangular wave modulation period.

In particular, the Doppler frequency may have a linear relationship with the difference between the frequency of the falling period of the triangular wave modulation period and the frequency of the rising period of the triangular wave modulation period.

In one embodiment, the determination the vertical velocity of the microwave radar relative to the reflecting target based on the Doppler frequency may include: acquiring wavelength information corresponding to a center frequency of the transmitted signal, and determining the vertical velocity of the microwave radar relative to the reflecting target based on the Doppler frequency and the wavelength information.

In particular, the vertical velocity of the microwave radar relative to the reflecting target may have a linear relationship with the product of the Doppler frequency and the wavelength information.

The specific principles and implementation manners of the computer storage medium provided in the present embodiment are similar to the embodiments shown in FIGS. 1-6, and detailed are not described herein again.

In the computer storage medium provided in the present disclosure, by using the program instructions stored in the computer storage medium, the height information of the microwave radar and the landscape information formed by a plurality of reflecting targets may be determined by controlling the signal transmitter of the microwave radar to transmit a microwave signal while rotating around a rotating shaft, acquiring the frequency of the intermediate frequency signal, and determining the distance between the microwave radar and the reflecting targets based on the frequency of the intermediate frequency signal. Further, when the microwave radar is mounted on the UAV, the safety and reliability of the flight of the UAV may be effectively ensured and the practicality of the microwave radar may be improved, which is beneficially to the market promotion and application.

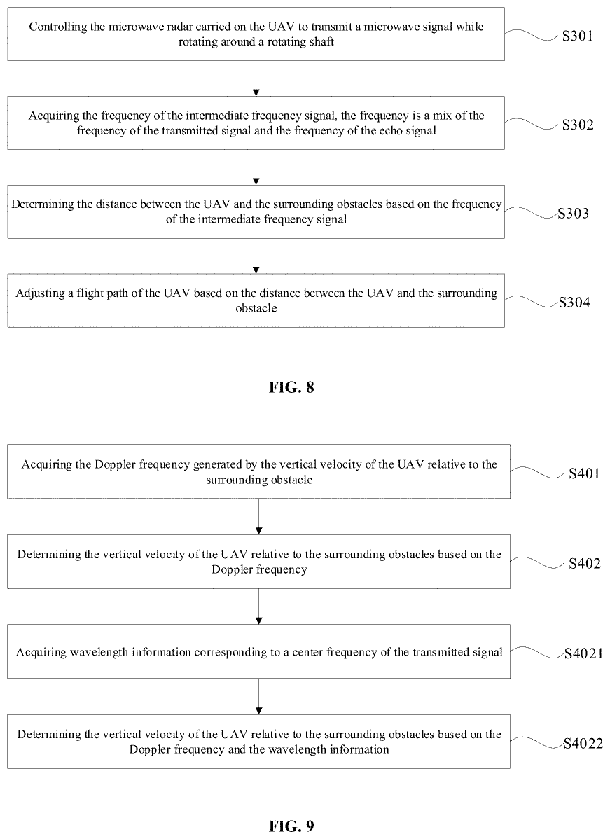

FIG. 8 is a flowchart illustrating a UAV control method according to an embodiment of the present disclosure. As can be seen in FIG. 8, the present embodiment provides a UAV control method. A microwave radar may be carried on the UAV, and the control method may be used for adjusting and controlling the flight state of the UAV. The UAV control method is described in detail below.

S301, controlling the microwave radar carried on the UAV to transmit a microwave signal while rotating around a rotating shaft.

In particular, a microwave radar may be carried on the UAV, and the microwave radar may be configured to perform a rotational movement around a rotating shaft.

S302, acquiring the frequency of the intermediate frequency signal that is a mix of the frequency of the transmitted signal and the frequency of the echo signal.

More specifically, acquiring the frequency of the intermediate frequency signal after the mix of the frequency of the transmitted signal and the frequency of the echo signal may include: acquiring the frequency of the rising period of a triangular wave modulation period and the frequency of the falling period of the triangular wave modulation period after performing the triangular wave frequency modulation on the transmitted signal; and determining the frequency of the intermediate frequency signal based on the frequency of the rising period of the triangular wave modulation period and the frequency of the falling period of the triangular wave modulation period.

In particular, the frequency of the intermediate frequency signal may have a linearly relationship with sum of the frequency of the rising period of the triangular wave modulation period and the frequency of the falling period of the triangular wave modulation period.

S303, determining the distance between the UAV and the surrounding obstacles based on the frequency of the intermediate frequency signal.

In one embodiment, the surrounding obstacles may include one or more reflecting targets, that is, objects that may receive the transmitted signal and return the echo signal. As such, the flight state of the UAV may be accurately acquired, and the UAV may be accurately controlled. Further, determining the distance between the UAV and the surrounding obstacles based on the frequency of the intermediate frequency signal may include: acquiring time-frequency information after performing the triangular wave frequency modulation on the transmitted signal; and determining the distance between the UAV and the surrounding obstacles based on the time-frequency information and the frequency of the intermediate frequency signal.

The time-frequency information may include 0.5 times of a modulation bandwidth, a triangular wave modulation period, and an electromagnetic wave propagation speed. Further, the distance between the UAV and the surrounding obstacles may have a linear relationship with the product of the frequency of the intermediate frequency signal, the triangular wave modulation period, and the electromagnetic wave propagation speed. Furthermore, the distance between the UAV and the surrounding obstacles may be inversely proportional to the 0.5 times of the modulation bandwidth.

S304, adjusting a flight path of the UAV based on the distance between the UAV and the surrounding obstacles.

After acquiring the distance between the UAV and the surrounding obstacles, the distance may be analyzed to adjust the flight path of the UAV. More specifically, the distance may be compared with a predetermined first distance threshold. If the distance is less than or equal to the first distance threshold, the distance between the UAV and the surrounding obstacles may be relatively close. As such, in order to ensure the safety and reliability of the UAV, the flight path of the UAV may be adjusted to be a path away from the surround obstacles. If the distance is greater than the first distance threshold and less than or equal to a second distance threshold, where the second distance threshold may be greater than the first distance threshold, the distance between the UAV and the surrounding obstacles may be moderate, and the UAV may remain on its original flight path. If the distance is greater than the second distance threshold, it may indicate that the UAV may be far away from the surround obstacles. As such, in order to ensure the working efficiency and the accuracy of the UAV, the flight path of the UAV may be adjusted to be closer to the surrounding obstacles. The specific implementation process for adjusting the flight path of the UAV is not limited in the present disclosure, and those skilled in the art may also adopt other adjustment methods based on the specific design requirements.

FIG. 9 is a flowchart illustrating the UAV control method according to another embodiment of the present disclosure. As can be seen from FIG. 9, in order to further improve the accuracy of the control of the UAV, the UAV control method may be set as follow.

S401, acquiring the Doppler frequency generated by the vertical velocity of the UAV relative to the surrounding obstacles.

In one embodiment, acquiring the Doppler frequency generated by the vertical velocity of the UAV relative to the surrounding obstacles may include: acquiring the frequency of the rising period of the triangular wave modulation period and the frequency of the falling period of the triangular wave modulation period after performing the triangular wave frequency modulation on the transmitted signal; and determining the Doppler frequency based on the frequency of the rising period of the triangular wave modulation period and the frequency of the falling period of the triangular wave modulation period.

In particular, the Doppler frequency may have a linear relationship with the difference between the frequency of the falling period of the triangular wave modulation period and the frequency of the rising period of the triangular wave modulation period

S402, determining the vertical velocity of the UAV relative to the surrounding obstacles based on the Doppler frequency.

In one embodiment, determining the vertical velocity of the UAV relative to the surrounding obstacles based on the Doppler frequency may be set as follow.

S4021, acquiring wavelength information corresponding to a center frequency of the transmitted signal.

S4022, determining the vertical velocity of the UAV relative to the surrounding obstacles based on the Doppler frequency and the wavelength information.

In particular, the vertical velocity of the UAV relative to the surrounding obstacles may have a linear relationship with the product of the Doppler frequency and the wavelength information

The specific principles and implementation manners of the UAV control method provided in the present embodiment are similar to the embodiments shown in FIGS. 1-6, and detailed are not described herein again.

By using the UAV control method provided in the present disclosure, the height information of the microwave radar and the landscape information formed by a plurality of reflecting targets may be determined by controlling the signal transmitter of the microwave radar carried on the UAV to transmit a microwave signal while rotating around a rotating shaft, acquiring the frequency of the intermediate frequency signal, and determining the distance between the UAV and the surround obstacles based on the frequency of the intermediate frequency signal. Further, when the microwave radar is mounted on the UAV, the safety and reliability of the flight of the UAV may be effectively ensured and the practicality of the microwave radar may be improved, which is beneficially to the market promotion and application.

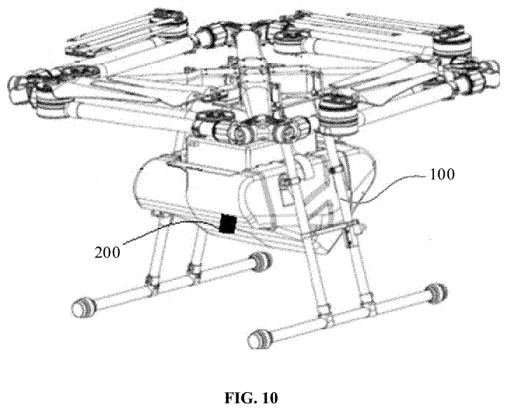

FIG. 10 is a structural diagram illustrating a UAV according to an embodiment of the present disclosure. Referring to FIG. 10, the present embodiment provides a UAV, and the UAV includes 1 frame 100; a microwave radar 200 mounted on the frame 100 and configured to rotate around a rotating shaft; and a flight controller connected to the microwave radar 200.

The microwave radar 200 may be configured to transmit a microwave signal while rotating around a rotating shaft, acquire the frequency of the intermediate frequency signal that is a mix of the frequency of the transmitted signal and the frequency of the echo signal, and determine the distance between the UAV and the surrounding obstacles based on the frequency of the intermediate frequency signal that is a mix of the frequency of the transmitted signal and the frequency of the echo signal. Further, the flight controller may be used to adjust the flight path of the UAV based on the distance between the UAV and the surrounding obstacles.

More specifically, when the microwave radar 200 is used to acquire the frequency of the intermediate frequency signal that is a mix of the frequency of the transmitted signal and the frequency of the echo signal, the microwave radar 200 may be configured to: acquire the frequency of the rising period of a triangular wave modulation period and the frequency of the falling period of the triangular wave modulation period after performing the triangular wave frequency modulation on the transmitted signal; and determine the frequency of the intermediate frequency signal based on the frequency of the rising period of the triangular wave modulation period and the frequency of the falling period of the triangular wave modulation period.

In particular, the frequency of the intermediate frequency signal may have a linearly relationship with sum of the frequency of the rising period of the triangular wave modulation period and the frequency of the falling period of the triangular wave modulation period.

Further, when the microwave radar 200 is used to determine the distance between the UAV and the surrounding obstacles based on the frequency of the intermediate frequency signal that is a mix of the frequency of the transmitted signal and the frequency of the echo signal, the microwave radar 200 may be configured to: acquire time-frequency information after performing the triangular wave frequency modulation on the transmitted signal; and determine the distance between the UAV and the surrounding obstacles based on the time-frequency information and the frequency of the intermediate frequency signal.

The time-frequency information may include 0.5 times of a modulation bandwidth, a triangular wave modulation period, and an electromagnetic wave propagation speed. Further, the distance between the UAV and the surrounding obstacles may have a linear relationship with the product of the frequency of the intermediate frequency signal, the triangular wave modulation period, and the electromagnetic wave propagation speed. Furthermore, the distance between the UAV and the surrounding obstacles may be inversely proportional to the 0.5 times of the modulation bandwidth.

After the flight controller acquires the distance between the UAV and the surrounding obstacles, the distance may be analyzed to adjust the flight path of the UAV. More specifically, the specific principle and implementation manner of the adjustment of the flight path of the UAV based on the distance between the UAV and the surrounding obstacles may be similar to the specific principle and implementation manner in S304 mentioned in the previous embodiment. For detail, reference may be made to the previous embodiment.

In order to further improve the safety and reliability of operation of the UAV, in the present embodiment, the microwave radar 200 may be further configured to acquire the Doppler frequency generated by the vertical velocity of the UAV relative to the surrounding obstacles, and determine the vertical velocity of the UAV relative to the surrounding obstacles.

In one embodiment, when the microwave radar 200 is used to determine the vertical velocity of the UAV relative to the surrounding obstacles based on the Doppler frequency, the microwave radar 200 may be further configured to: acquiring wavelength information corresponding to a center frequency of the transmitted signal, and determine the vertical velocity of the UAV relative to the surrounding obstacles based on the Doppler frequency and the wavelength information.

In particular, the vertical velocity of the UAV relative to the surrounding obstacles may have a linear relationship with the product of the Doppler frequency and the wavelength information.

In one embodiment, when the microwave radar 200 is used to acquire the Doppler frequency generated by the vertical velocity of the microwave radar relative to the reflecting target, the microwave radar 200 may be further configured to: acquire the frequency of the rising period of the triangular wave modulation period and the frequency of the falling period of the triangular wave modulation period after performing the triangular wave frequency modulation on the transmitted signal; and determine the Doppler frequency based on the frequency of the rising period of the triangular wave modulation period and the frequency of the falling period of the triangular wave modulation period.

In particular, the Doppler frequency may have a linear relationship with the difference between the frequency of the falling period of the triangular wave modulation period and the frequency of the rising period of the triangular wave modulation period.

In one embodiment, the UAV may be applied to the field of agricultural technology, that is, it may be an agricultural plant protection machine. In addition, in order to ensure the operational reliability of the microwave radar 200 mounted on the UAV, the operating bandwidth of the antenna signal transmitted by the microwave radar 200 described above may be set between 24.05 GHz and 24.25 GHz. Further, in order to ensure the integrity of a scanning area of the antenna signal transmitted by the microwave radar 200, a pitch angle of the microwave radar 200 may be set to be greater than or equal to 10°, and the horizontal narrow beam of the microwave radar 200 may be set to be less than or equal to 5°. In one embodiment, the pitch angle of the microwave radar 200 may be used to scan the overall state an object. The specific value of the pitch angle setting needs to be applied to the terrain, and different terrains may have different pitch angles. The horizontal narrow beam of the microwave radar 200 may be used to reflect the scanning precision of the antenna signal transmitted by the microwave radar 200. When the angle of the horizontal narrow beam becomes smaller, the accuracy of the scanning may be higher, and the acquired data may be more accurate and reliable.

The specific principles and implementations of the UAV provided in the present embodiment are similar to the embodiments shown in FIGS. 1-6, and detailed are not described herein again.

By using the UAV provided in the present disclosure, the height information of the microwave radar and the landscape information formed by a plurality of reflecting targets may be determined by controlling the signal transmitter of the microwave radar 200 to transmit a microwave signal while rotating around a rotating shaft, acquiring the frequency of the intermediate frequency signal, and determining the distance between the UAV and the surround obstacles based on the frequency of the intermediate frequency signal. As such, the control precision of the flight controller to the UAV ma be improved, the safety and reliability of the flight of the UAV may be effectively ensured and the practicality of the microwave radar may be improved, which is beneficially to the market promotion and application.

The technical solutions and technical features of the various embodiments mentioned above can be used alone or in combination without conflicting with the present disclosure. As long as it does not go beyond the scope of knowledge of those skilled in the art, there modifications should be considered as the equivalent embodiments within the scope of the present disclosure.

In the several embodiments provided in the present application, it should be understood that the disclosed apparatus and method may be implemented in other manners. For example, the described apparatus embodiment is merely exemplary. For example, the unit or module division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. A part or all of the units may be selected according to actual needs to achieve the objectives of the solutions of the embodiments of the present disclosure.

In addition, functional units in the embodiments of the present disclosure may be integrated into one processing unit, or each of the units may exist alone physically, or two or more units are integrated into one unit. The integrated unit may be implemented in a form of hardware, or may be implemented in a form of a software functional unit.

When the integrated unit is implemented in a form of a software functional unit and sold or used as an independent product, the functions may be stored in a computer-readable storage medium. Based on such an understanding, the technical solutions of the present disclosure essentially, or the part contributing to the prior art, or a part of the technical solutions may be implemented in a form of a software product. The computer software product is stored in a storage medium and includes several instructions for instructing a processor to perform all or a part of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

The above description merely illustrates some embodiments of the disclosure and is not intended to limit the scope of the disclosure. Any equivalent changes in structures or processes made in light of the specification and the drawings, and their direct or indirect application in other related technical fields should all be encompassed in the scope of the present disclosure.

It should be noted that the foregoing embodiments are merely intended for describing the technical solutions of the present disclosure instead of limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. An unmanned aerial vehicle (UAV) control method, comprising:
controlling a microwave radar disposed on the UAV to transmit a microwave signal while rotating around a rotating shaft;
acquiring a frequency of an intermediate frequency signal based on a frequency of the transmitted signal and a frequency of an echo signal;
determining a distance between the UAV and a surrounding obstacle based on the frequency of the intermediate frequency signal; and
adjusting a flight path of the UAV based on the distance between the UAV and the surrounding obstacle.

2. The method of claim 1, wherein determining the distance between the UAV and the surrounding obstacle based on the frequency of the intermediate frequency signal includes:
acquiring time-frequency information after performing a triangular wave frequency modulation on the transmitted signal;
determining the distance between the UAV and the surrounding obstacle based on the time-frequency information and the frequency of the intermediate frequency signal.

3. The method of claim 2, wherein the time-frequency information includes 0.5 times of a modulation bandwidth, a triangular wave modulation period, and an electromagnetic wave propagation speed.

4. The method of claim 3, wherein the distance between the UAV and the surrounding obstacle has a linear relationship with the product of the frequency of the intermediate frequency signal, the triangular wave modulation period, and the electromagnetic wave propagation speed, and the distance between the UAV and the surrounding obstacle is inversely proportional to the 0.5 times of the modulation bandwidth.

5. The method of claim 1, further comprising:
acquiring a Doppler frequency generated by a vertical velocity of the UAV relative to the surrounding obstacle; and
determining the vertical velocity of the UAV relative to the surrounding obstacle based on the Doppler frequency.

6. The method of claim 5, wherein determining the vertical velocity of the UAV relative to the surrounding obstacle based on the Doppler frequency includes:
acquiring wavelength information corresponding to a center frequency of the transmitted signal; and
determining the vertical velocity of the UAV relative to the surrounding obstacle based on the Doppler frequency and the wavelength information.

7. The method of claim 6, wherein the vertical velocity of the UAV relative to the surrounding obstacle has a linear relationship with the product of the Doppler frequency and the wavelength information.

8. The method of claim 5, wherein acquiring the Doppler frequency generated by the vertical velocity of the UAV relative to the surrounding obstacle includes:
acquiring a frequency of a rising period of the triangular wave modulation period and a frequency of a falling period of the triangular wave modulation period after performing the triangular wave frequency modulation on the transmitted signal; and
determining the Doppler frequency based on the frequency of the rising period of the triangular wave modulation period and the frequency of the falling period of the triangular wave modulation period.

9. The method of claim 8, wherein the Doppler frequency has a linear relationship with the difference between the frequency of the falling period of the triangular wave modulation period and the frequency of the rising period of the triangular wave modulation period.

10. The method of claim 1, wherein acquiring the frequency of the intermediate frequency signal based on the frequency of the transmitted signal and the frequency of the echo signal includes:
acquiring a frequency of a rising period of a triangular wave modulation period and a frequency of a falling period of the triangular wave modulation period after performing a triangular wave frequency modulation on the transmitted signal; and
determining the frequency of the intermediate frequency signal based on the frequency of the rising period of the triangular wave modulation period and the frequency of the falling period of the triangular wave modulation period.

11. The method of claim 10, wherein the frequency of the intermediate frequency signal has a linear relationship with the sum of the frequency of the rising period of the triangular wave modulation period and the frequency of the falling period of the triangular wave modulation period.

12. A UAV, comprising:
a frame;
a microwave radar mounted on the frame, and the microwave is rotatable around a rotation shaft; and
a flight controller communicatively connected to the microwave radar;
wherein the microwave radar is configured to transmit a microwave signal while rotating around the rotating shaft, acquire a frequency of an intermediate frequency signal according to a frequency of the transmitted signal and a frequency of an echo signal, and determine a distance between the UAV and a surrounding obstacle based on the frequency of the intermediate frequency signal; and the flight controller is configured to adjust a flight path of the UAV based on the distance between the UAV and the surrounding obstacle.

13. The UAV of claim 12, wherein the microwave radar is further configured to:
acquire time-frequency information after performing a triangular wave frequency modulation on the transmitted signal;
determine the distance between the UAV and the surrounding obstacle based on the time-frequency information and the frequency of the intermediate frequency signal.

14. The UAV of claim 13, wherein the time-frequency information includes 0.5 times of a modulation bandwidth, a triangular wave modulation period, and an electromagnetic wave propagation speed.

15. The UAV of claim 14, wherein the distance between the UAV and the surrounding obstacle has a linear relationship with the product of the frequency of the intermediate frequency signal, the triangular wave modulation period, and the electromagnetic wave propagation speed, and the distance between the UAV and the surrounding obstacle is inversely proportional to the 0.5 times of the modulation bandwidth.

16. The UAV of claim 12, wherein the microwave radar is further configured to:
acquire a Doppler frequency generated by a vertical velocity of the UAV relative to the surrounding obstacle; and
determine the vertical velocity of the UAV relative to the surrounding obstacle based on the Doppler frequency.

17. The UAV of claim 16, wherein the microwave radar is further configured to:
acquire wavelength information corresponding to a center frequency of the transmitted signal; and
determine the vertical velocity of the UAV relative to the surrounding obstacle based on the Doppler frequency and the wavelength information.

18. The UAV of claim 17, wherein the vertical velocity of the UAV relative to the surrounding obstacle has a linear relationship with the product of the Doppler frequency and the wavelength information.

19. The UAV of claim 16, wherein the microwave radar is further configured to:
acquire a frequency of a rising period of the triangular wave modulation period and a frequency of a falling period of the triangular wave modulation period after performing the triangular wave frequency modulation on the transmitted signal; and
determine the Doppler frequency based on the frequency of the rising period of the triangular wave modulation period and the frequency of the falling period of the triangular wave modulation period.

20. The UAV of claim 19, wherein the Doppler frequency has a linear relationship with the difference between the frequency of the falling period of the triangular wave modulation period and the frequency of the rising period of the triangular wave modulation period.

21. The UAV of claim 12, wherein the microwave radar is further configured to:
acquire a frequency of a rising period of a triangular wave modulation period and a frequency of a falling period of the triangular wave modulation period after performing a triangular wave frequency modulation on the transmitted signal; and
determine the frequency of the intermediate frequency signal based on the frequency of the rising period of the triangular wave modulation period and the frequency of the falling period of the triangular wave modulation period.

22. The UAV of claim 21, wherein the frequency of the intermediate frequency signal has a linear relationship with the sum of the frequency of the rising period of the triangular wave modulation period and the frequency of the falling period of the triangular wave modulation period.
